(19) United States
(12) Patent Application Publication
(10) Pub. No.: US 2007/0011640 A1
(43) Pub. Date: Jan. 11, 2007

(54) LSI circuit

(76) Inventor: Takashi Hirata, Osaka (JP)

Correspondence Address: MCDERMOTT WILL & EMERY LLP, 600 13TH STREET, N.W., WASHINGTON, DC, 20005-3096, US

(21) Appl. No.: 11/480,479

(22) Filed: Jul. 5, 2006

(30) Foreign Application Priority Data
Jul. 5, 2005 (JP) 2005-196590

(51) Int. Cl. G06F 17/50

(52) U.S. Cl. 716/13; 716/10

(57) ABSTRACT

A power line for supplying a power supply voltage to a clock buffer and a power line for supplying a power supply voltage to another circuit are isolated from each other in both a semiconductor integrated circuit and a semiconductor package. Accordingly, even when power supply noise occurs in the circuit in the integrated circuit but also when a potential variation occurs in a power supply voltage supplied to the circuit in the package, entering of the power noise in the clock buffer is suppressed. Since a power line for the clock buffer is a dedicated line, the amount of current flowing in this power line is reduced, and the potential-variation amount of a power supply voltage supplied to the clock buffer is further reduced. Accordingly, even when variation of a power supply voltage occurs in a non-clock system circuit, clock jitter in a clock system circuit is effectively suppressed.

### CROSS-REFERENCE TO RELATED APPLICATION

This Non-provisional application claims priority under 35 U.S.C.§ 119(a) on Patent Application No. 2005-196590 filed in Japan on Jul. 5, 2005, the entire contents of which are hereby incorporated by reference.

### BACKGROUND OF THE INVENTION

The present invention relates to semiconductor devices, and particularly relates to measures against clock jitter.

With decrease of operation voltage and increase of power consumption in recent semiconductor integrated circuits, the ratio between a power supply voltage and switching noise in a semiconductor integrated circuit has decreased and the influence of power supply noise on circuit operation of the semiconductor integrated circuit has increased. In particular, increase of clock jitter caused by power supply noise causes a timing margin of circuit operation of a synchronous circuit to decrease. In view of this, to achieve high-speed operation of semiconductor integrated circuits, measures against clock jitter have become an important issue.

Hereinafter, a conventional technique as measures against clock jitter in a semiconductor integrated circuit will be described.

Examples of a conventional semiconductor integrated circuit in which clock jitter is reduced includes a technique described in Japanese Unexamined Patent Publication No. 6-310656.

FIG. 6 illustrates a conventional technique related to a method for connecting power lines disclosed in Japanese Unexamined Patent Publication No. 6-310656. In FIG. 6, a data system circuit 110 and a clock system circuit 111 are provided on a semiconductor board 100. A Vcc bonding pad 120 for supplying a high-potential-side power supply voltage and a Vss bonding pad 121 for supplying a low-potential-side power supply voltage are also provided. Power lines 130 and 131 for supplying a high-potential-side power supply voltage Vcc are individually formed and connected to the common Vcc bonding pad 120. Power lines 135 and 136 for supplying a low-potential-side power supply voltage Vss are also individually formed and connected to the common Vss bonding pad 121. The power lines 130 and 135 serving as a pair are connected to the data system circuit 110, whereas the power lines 131 and 136 serving as another pair are connected to the clock system circuit 111.

In this manner, in the configuration of the power lines disclosed in Japanese Unexamined Patent Publication No. 6-310656, the pair of power lines 130 and 135 for data system circuit 110 and the pair of power lines 131 and 136 for the clock system circuit 111 are separated from each other and are connected to the Vcc bonding pad 120 and the Vss bonding pad 121 which are power input terminals and provided on the semiconductor board 100. Accordingly, propagation of power supply noise in the power lines 130 and 135 for the data system circuit 110 to the power lines 131 and 136 for the clock system circuit 111 is suppressed, thus enabling reduction of clock jitter.

However, in a case in which the technique disclosed in Japanese Unexamined Patent Publication No. 6-310656 is used as measures against the clock jitter, the Vcc and Vss bonding pads 120 and 121 are connected to respective Vcc and Vss external power supply input terminals of a semiconductor package. In this case, when power lines are divided at the bonding pads 120 and 121, which are power supply input terminals of the semiconductor integrated circuit, and power supply voltages are supplied to the data system circuit 110 and the clock system circuit 111, current in an amount equal to the sum of the amount of current flowing in the data system circuit 110 and the amount of current flowing in the clock system circuit 111, flows in the shared power lines connecting the external power supply input terminals of the semiconductor package and the bonding pads 120 and 121. The amount of a variation in potential of a power supply voltage supplied from an external power supply input terminal of the semiconductor package is determined by a parasitic inductance L, a parasitic resistance R and a parasitic capacitance C, which are electrical parasitic components of the semiconductor package, and the amount of current flowing in the power lines. Accordingly, the amount of a variation in potential of a power supply voltage supplied to each of the bonding pads 120 and 121 to which the power lines are coupled is larger than that in a case where one of the pairs of power lines for the data system circuit 110 and the clock system circuit 111 is connected. As a result, a power supply voltage subjected to the potential variation depending on the amount of current flowing in the data system circuit 110 and the amount of current flowing in the clock system circuit 111 is supplied to each of the Vcc and Vss bonding pads 120 and 121, so that the amount of a variation of the potential thereof is large, and it is difficult to control clock jitter in the clock system circuit 111 accordingly.

### SUMMARY OF THE INVENTION

It is therefore an object of the present invention to reduce, in a semiconductor device including a section for a clock system (i.e., the clock system section) and a section for a system which is not a clock system (i.e., a non-clock system section), clock jitter in the clock system section caused by an influence of a variation in power supply voltage in the non-clock system section.

To achieve the object, according to the present invention, in a semiconductor device including a clock system section and a non-clock system section, measures are taken to make a potential variation in a power line for supplying a power supply voltage to the non-clock system section less affect a power line for supplying a power supply voltage to the clock system section, as compared to conventional techniques.

Specifically, a semiconductor device according to the present invention includes a semiconductor integrated circuit including a clock system circuit and a non-clock system circuit on a semiconductor board and also includes a semiconductor package in which the semiconductor integrated circuit is sealed. The semiconductor device includes: a power line for supplying a power supply voltage to the clock system circuit; and a power line for supplying a power supply voltage to the non-clock system circuit, wherein the two power lines are isolated from each other in the semiconductor integrated circuit and in the semiconductor package.

In one aspect of the present invention, each of the power line for supplying a power supply voltage to the clock system circuit and the power line for supplying a power supply voltage to the non-clock system circuit includes a ground line.

In another aspect of the present invention, the clock system circuit includes a clock driver for outputting a clock signal to outside the semiconductor integrated circuit, the power line for supplying a power supply voltage to the clock driver and the power line for supplying a power supply voltage to the clock system circuit are formed as separate lines, and the power line for supplying a power supply voltage to the clock system circuit and the power line for supplying a power supply voltage to the clock driver are isolated from each other in the semiconductor integrated circuit and in the semiconductor package.

In another aspect of the present invention, the non-clock system circuit includes a data driver for outputting a processing result in the semiconductor integrated circuit to outside the semiconductor integrated circuit, the power line for supplying a power supply voltage to the data driver and the power line for supplying a power supply voltage to the non-clock system circuit are formed as separate lines, and the power line for supplying a power supply voltage to the non-clock system circuit and the power line for supplying a power supply voltage to the data driver are isolated from each other in the semiconductor integrated circuit and in the semiconductor package.

A semiconductor device according to the present invention includes: a clock signal transmission line formed on a semiconductor printed board; a termination circuit placed at a termination of the clock signal transmission line and configured to suppress reflection of a clock signal; and a power supply for supplying a power supply voltage to the termination circuit, wherein the power supply associated with the termination circuit is isolated from another power supply.

In an aspect of the present invention, the power supply associated with the termination circuit is isolated from said another power supply by AC termination using a low-pass filter.

As described above, in a semiconductor device according to the present invention, a potential variation on a power line for supplying a power supply voltage to a non-clock system section less affects a power line for supplying a power supply voltage to a clock system section, as compared to conventional techniques. Accordingly, the amount of potential variation of the power supply voltage supplied to the clock system section is reduced.

In particular, in the semiconductor device of the present invention, the power line for supplying a power supply voltage to the clock system circuit and the power line for supplying a power supply voltage to the non-clock system circuit are individually formed and isolated from each other not only in the semiconductor integrated circuit but also in the semiconductor package. Accordingly, even when a potential variation of a power supply voltage supplied to the non-clock system circuit occurs in the semiconductor package, the influence of power supply noise on the clock system circuit is suppressed.

In addition, in the semiconductor device of the present invention, the power supply associated with the termination circuit of the clock signal transmission line is separated from another power supply. Accordingly, power supply noise occurring in another power supply is less likely to affect the power supply associated with the termination circuit of the clock signal transmission line on a semiconductor printed board.

### BRIEF DESCRIPTION OF THE DRAWINGS

FIG. 1 is a block diagram illustrating an overall configuration of a semiconductor device according to a first embodiment of the present invention.

FIG. 2 is a diagram illustrating a modified example of the semiconductor device.

FIG. 3A is a diagram illustrating another modified example of the semiconductor device and FIG. 3B is a diagram illustrating yet another modified example of the semiconductor device.

FIG. 4 is a block diagram illustrating an overall configuration of a semiconductor device according to a second embodiment of the present invention.

FIG. 5A is a graph showing a waveform of a clock signal in a case where a power supply voltage supplied to a termination circuit of a non-clock system circuit does not vary in the semiconductor device. FIG. 5B is a graph for explaining that even when the power supply voltage supplied to the termination circuit of the non-clock system circuit varies in the semiconductor device, no clock jitter occurs in a clock signal.

FIG. 6 is a block diagram illustrating a main portion of a conventional semiconductor integrated circuit.

### DETAILED DESCRIPTION OF THE INVENTION

Hereinafter, preferred embodiments of the present invention will be described with reference to the attached drawings.

### EMBODIMENT 1

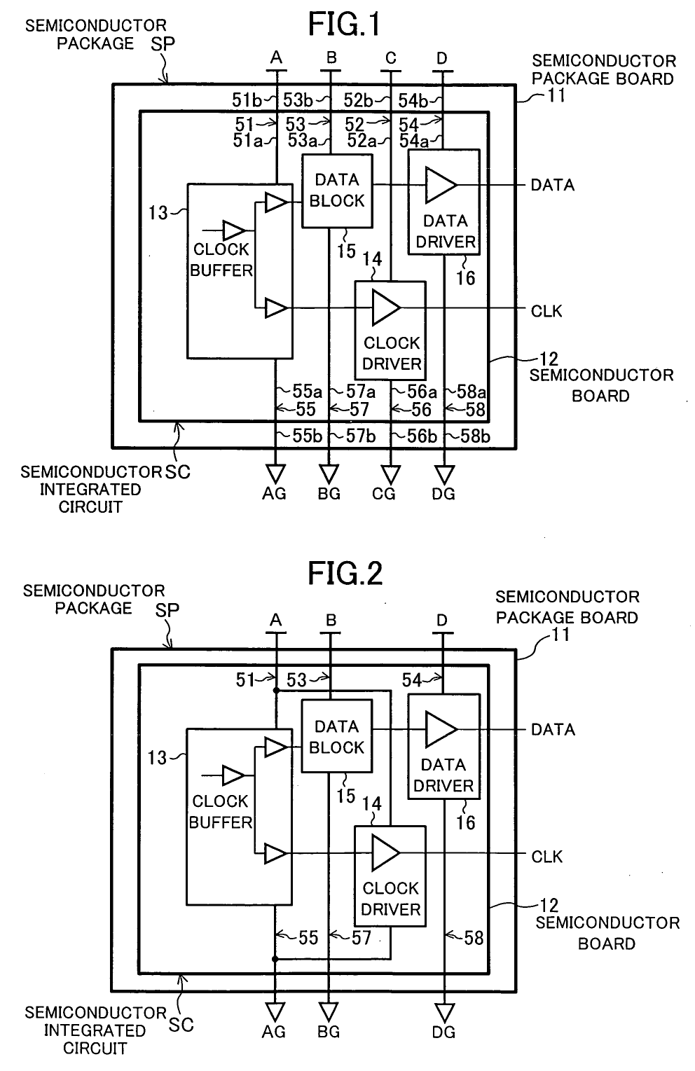

FIG. 1 is a block diagram illustrating a circuit configuration of a semiconductor device according to a first embodiment of the present invention.

In FIG. 1, SC denotes a semiconductor integrated circuit in which various circuits (which will be described below) are formed on a semiconductor board 12. SP denotes a semiconductor package including: a semiconductor package board 11 on which the semiconductor board 12 of the semiconductor integrated circuit SC is mounted; and a package body (not shown) in which the semiconductor integrated circuit SC is sealed together with the semiconductor package board 11. A clock buffer 13 for transmitting a clock signal and a clock driver 14 for outputting a clock signal to outside the semiconductor integrated circuit SC are provided on the semiconductor board 12 to form a clock system circuit. In addition, a data block 15 for performing data processing and a data driver 16 for outputting a result of data processing to outside the semiconductor integrated circuit SC are provided to form a circuit which is not a clock system circuit. Hereinafter, a circuit which is not a clock system circuit will be referred to as a non-clock system circuit. The clock buffer 13 transmits a clock signal for synchronization which was input from outside the semiconductor integrated circuit SC to the data block 15 and the clock driver 14. The data block 15 performs given data processing using the synchronization clock signal input from the clock buffer 13, and transmits a processing result to the data driver 16. The data driver 16 outputs a processing result DATA which was input from the data block 15 to outside the semiconductor integrated circuit SC. The clock driver 14 outputs a clock signal CLK to outside the semiconductor integrated circuit SC in synchronization with the data driver 16.

A feature of this embodiment is that a power line 51 and a ground line 55 are provided for the clock buffer 13. The power line 51 for the clock buffer 13 includes: a power line 51a formed on the semiconductor board 12 and connected to the clock buffer 13; and a power line 51b formed on the semiconductor package board 11 and connected to the power line 51a. The power line 51b is also connected to a power supply A exclusively for the clock buffer 13. The ground line 55 for the clock buffer 13 includes: a ground line 55a formed on the semiconductor board 12 and connected to the clock buffer 13; and a ground line 55b formed on the semiconductor package board 11 and connected to the ground line 55a. The ground line 55b is also connected to a ground AG exclusively for the clock buffer 13. Likewise, a power line 52 and a ground line 56 are provided for the clock driver 14. The power line 52 for the clock driver 14 includes: a power line 52a formed on the semiconductor board 12 and connected to the clock driver 14; and a power line 52b formed on the semiconductor package board 11 and connected to the power line 52a. The power line 52b is also connected to a power supply C exclusively for the clock driver 14. The ground line 56 for the clock driver 14 includes: a ground line 56a formed on the semiconductor board 12 and connected to the clock driver 14; and a ground line 56b formed on the semiconductor package board 11 and connected to the ground line 56a. The ground line 56b is also connected to a ground CG exclusively for the clock driver 14.

In addition, a power line 53 and a ground line 57 are provided for the data block 15. The power line 53 for the data block 15 includes: a power line 53a formed on the semiconductor board 12 and connected to the data block 15; and a power line 53b formed on the semiconductor package board 11 and connected to the power line 53a. The power line 53b is also connected to a power supply B exclusively for the data block 15. The ground line 57 for the data block 15 includes: a ground line 57a formed on the semiconductor board 12 and connected to the data block 15; and a ground line 57b formed on the semiconductor package board 11 and connected to the ground line 57a. The ground line 57b is also connected to a ground BG exclusively for the data block 15. Moreover, a power line 54 and a ground line 58 are provided for the data driver 16. The power line 54 for the data driver 16 includes: a power line 54a formed on the semiconductor board 12 and connected to the data driver 16; and a power line 54b formed on the semiconductor package board 11 and connected to the power line 54a. The power line 54b is also connected to a power line D exclusively for the data driver 16. The ground line 58 for the data driver 16 includes: a ground line 58a formed on the semiconductor board 12 and connected to the data driver 16; and a ground line 58b formed on the semiconductor package board 11 and connected to the ground line 58a. The ground line 58b is also connected to a ground DG exclusively for the data driver 16.

The power lines 51, 52, 53 and 54 for the respective circuit components 13, 14, 15 and 16 in the semiconductor integrated circuit SC are the dedicated power lines 51a, 52a, 53a and 54a, respectively, that are separated from each other in the semiconductor integrated circuit SC. The power lines 51, 52, 53 and 54 are the dedicated power lines 51b, 52b, 53b and 54b, respectively, that are separated from each other in the semiconductor package SP. The ground lines 55, 56, 57 and 58 for the respective circuit components 13 through 16 in the semiconductor integrated circuit SC are the dedicated ground lines 55a, 56a, 57a and 58a, respectively, that are separated from each other in the semiconductor integrated circuit SC. The ground lines 55, 56, 57 and 58 are the dedicated ground lines 55b, 56b, 57b and 58b, respectively, that are separated from each other in the semiconductor package SP.

As described above, in this embodiment, the power lines 51 and 52 for the components 13 and 14 of the clock system circuit and the power lines 53 and 54 for the components 15 and 16 of the non-clock system circuit are separated from each other in the semiconductor integrated circuit SC and the semiconductor package SP so that power supply voltages are individually supplied thereto. In this manner, it is possible to effectively suppress propagation of power supply noise occurring in the non-clock system circuit components 15 and 16 or a potential variation on the power lines 53 and 54 for the non-clock system circuit components 15 and 16 to the power lines 51 and 52 for the clock system circuit components 13 and 14, and the power supply noise or the potential variation is less likely to affect the clock system circuit components 13 and 14, as compared to conventional techniques.

In addition, with respect to the ground lines, the ground lines 55 and 56 for the clock system circuit components 13 and 14 and the ground lines 57 and 58 for the non-clock system circuit components 15 and 16 are separated from each other and are individually connected to the grounds. Accordingly, ground noise caused by current flowing from the non-clock system circuit components 15 and 16 to the grounds is much less likely to propagate into the ground lines 55 and 56 for the clock system circuit components 13 and 14 and enter the clock system circuit components 13 and 14.

The power lines 51 and 52 for the clock system circuit components 13 and 14 and the power lines 53 and 54 for the non-clock system circuit components 15 and 16 are separated from each other. The ground lines 55 and 56 for the clock system circuit components 13 and 14 and the ground lines 57 and 58 for the non-clock system circuit components 15 and 16 are separated from each other. Accordingly, the amounts of current flowing in the power lines 51 and 52 and the ground lines 55 and 56 for the clock system circuit components 13 and 14 are smaller than those in a configuration in which the clock system circuit components 13 and 14 and the non-clock system circuit components 15 and 16 are connected through one power line and one ground line, by the amount of current flowing in the non-clock system circuit components 15 and 16. As a result, the amount of a variation in potential is reduced in the power lines 51 and 52 and the ground lines 55 and 56 for the clock system circuit components 13 and 14.

With respect to the clock system circuit components 13 and 14, the power line 51 and the ground line 55 for the clock buffer 13 and the power line 52 and the ground line 56 for the clock driver 14 may be individually formed and separated from each other, so that power supply noise occurring in the clock driver 14 is less likely to propagate into the power line 51 and the ground line 55 for the clock buffer 13 and affect the clock buffer 13. The power line 51 for the clock buffer 13 and the power line 52 for the clock driver 14 are separated from each other and the ground line 55 for the clock buffer 13 and the ground line 56 for the clock driver 14 are separated from each other, so that the amount of current flowing in the power line 51 and the ground line 55 for the clock buffer 13 is smaller than that in a configuration in which the clock buffer 13 and the clock driver 14 are connected through one power line and one ground line, by the amount of current flowing in the clock driver 14. Accordingly, the amount of potential variation in the power line 51 and the ground line 55 for the clock buffer 13 is reduced.

In addition, with respect to the non-clock system circuit, the power line 53 and the ground line 57 for the data block 15 and the power line 54 and the ground line 58 for the data driver 16 are separated from each other, so that the amounts of current flowing in the power lines 53 and 54 and the ground lines 57 and 58 for the data block 15 and the data driver 16 are reduced, and the amounts of potential variations in the non-clock system circuit components 15 and 16 and the power lines 53 and 54 and the ground lines 57 and 58 are reduced. Accordingly, stable data transmission is expected.

As a result, not only when power supply noise and ground noise occur in the non-clock system circuit components 15 and 16 and the associated power lines 53 and 54 and ground lines 57 and 58 in the semiconductor integrated circuit SC, but also when potential variations of power supply voltages supplied to the non-clock system circuit components 15 and 16 occur in the semiconductor package SP, propagation of the power supply noise and the ground noise into the clock system circuit components 13 and 14 is suppressed, thus enabling further reduction of clock jitter in the clock system circuit components 13 and 14. In addition, in the clock buffer 13, clock jitter of a clock signal transmitted to the inside of the semiconductor integrated circuit SC is allowed to be further reduced, as compared to conventional techniques, with reduction of clock jitter of a clock signal transmitted to outside the semiconductor integrated circuit SC in the clock driver 14.

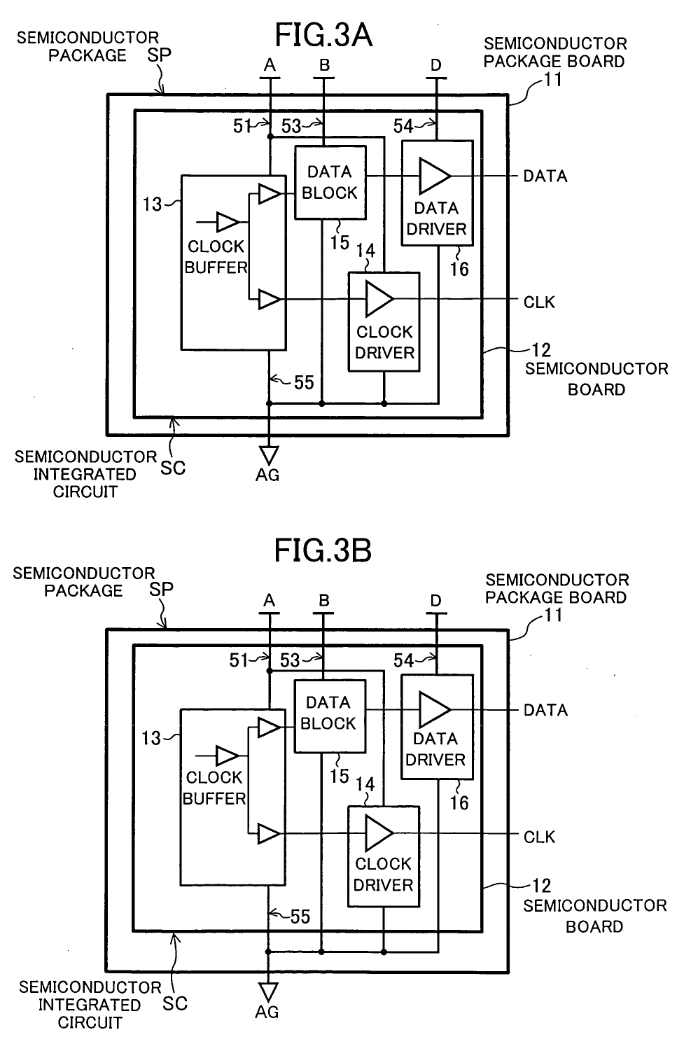

As illustrated in FIG. 2, the power line 51 may be shared by the clock driver 14 and the clock buffer 13 and the ground line 55 may be shared by the clock driver 14 and the clock buffer 13. In this case, propagation of power supply noise occurring in the data block 15 and the data driver 16 forming the non-clock system circuit into the clock system circuit components 13 and 14 is effectively suppressed, thus reducing clock jitter, as compared to conventional techniques. As illustrated in FIGS. 3A and 3B, the ground lines 55 through 58 for the respective circuit components 13 through 16 may be one ground line on the semiconductor board 12 or the semiconductor package board 11. In such a case, the same effect of suppressing clock jitter is expected.

### EMBODIMENT 2

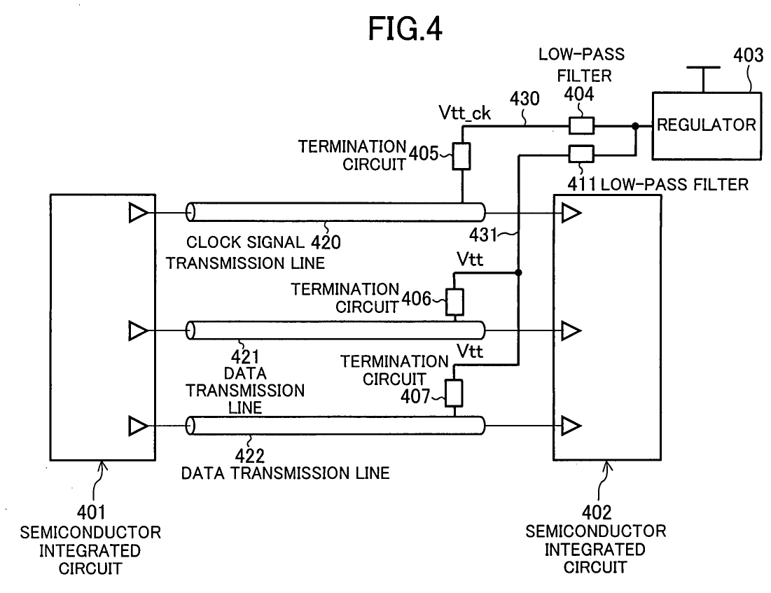

FIG. 4 is a block diagram illustrating a circuit configuration of a semiconductor device according to a second embodiment of the present invention.

In FIG. 4, two semiconductor integrated circuits 401 and 402 are provided on a semiconductor printed board (not shown). The semiconductor integrated circuits 401 and 402 are coupled through a clock signal transmission line 420 for transmitting a clock signal and data transmission lines 421 and 422 for transmitting signals (i.e., data) other than a clock signal. A termination circuit 405 for suppressing reflection of a clock signal is provided at the termination of the clock signal transmission line 420. Termination circuits 406 and 407 for suppressing reflection of data are also provided at the respective terminations of the data transmission lines 421 and 422.

Reference numeral 403 denotes a regulator for supplying a power supply voltage to the termination circuit 405 of the clock signal transmission line 420 and to the termination circuits 406 and 407 of the respective data transmission lines 421 and 422. Basically, the power supply voltage from the regulator 403 is supplied to the termination circuit 405 of the clock signal transmission line 420 through a power line 430 and also supplied to the termination circuits 406 and 407 of the data transmission lines 421 and 422 through a power line 431.

A feature of this embodiment is that low-pass filters 404 and 411 constituted by, for example, inductors and capacitors are provided on the semiconductor printed board. The low-pass filter 404 is placed on the power line 430, more specifically, between the regulator 403 and the termination circuit 405. A power supply voltage Vtt_ck is supplied to the termination circuit 405. The low-pass filter 411 is placed on the power line 431, more specifically, between the regulator 403 and the termination circuits 406 and 407. A power supply voltage Vtt is supplied to the termination circuits 406 and 407.

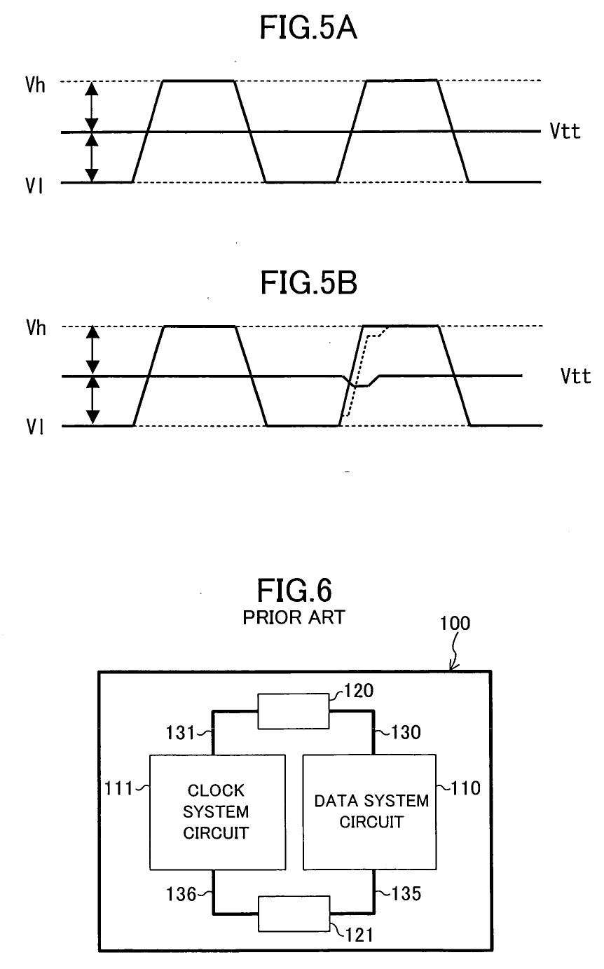

When no dynamic potential variation occurs in the power supply voltage Vtt supplied to the termination circuits 406 and 407 of the data transmission lines 421 and 422 for data transmission, a clock signal keeps the waveform as shown in FIG. 5A. In this embodiment, a power supply voltage Vtt is supplied with the termination circuit 405 of the clock signal transmission line 420 for clock-signal transmission separated from the other termination circuits 406 and 407 by AC termination. Accordingly, even when a dynamic potential variation of the power supply voltage Vtt supplied to the termination circuits 406 and 407 occurs, this dynamic variation does not affect the power supply voltage Vtt_ck at the termination circuit 405 of the clock signal transmission line 420. Accordingly, as shown in FIG. 5B, clock jitter with which the clock edge of a clock signal varies with time as indicated by the broken line in FIG. 5B is effectively suppressed and, as indicated by the solid line in FIG. 5B, an excellent waveform in which no dynamic variation of the power supply voltage Vtt occurs is kept as in the case of FIG. 5A.

As a result, even when a potential variation occurs in a power supply other than the power supply for the termination circuit 405 of the clock signal transmission line 420, it is possible to reduce the influence of this potential variation on a clock signal transmitted from one semiconductor integrated circuit 401 to another semiconductor integrated circuit 402 through the clock signal transmission line 420, so that clock jitter of the clock signal transmitted through the clock signal transmission line 420 is effectively suppressed.

In this embodiment, the power supply for the termination circuits 405 through 407 of the respective transmission lines 420 through 422 is separated by AC termination using the low-pass filters 404 and 411. Alternatively, to separate the power supply, a plurality of separate power supplies may be, of course, provided.

What is claimed is:

1. A semiconductor device which includes a semiconductor integrated circuit including a clock system circuit and a non-clock system circuit on a semiconductor board and also includes a semiconductor package in which the semiconductor integrated circuit is sealed, the semiconductor device comprising:
a power line for supplying a power supply voltage to the clock system circuit; and
a power line for supplying a power supply voltage to the non-clock system circuit,
wherein the two power lines are isolated from each other in the semiconductor integrated circuit and in the semiconductor package.

2. The semiconductor device of claim 1, wherein each of the power line for supplying a power supply voltage to the clock system circuit and the power line for supplying a power supply voltage to the non-clock system circuit includes a ground line.

3. The semiconductor device of claim 1, wherein the clock system circuit includes a clock driver for outputting a clock signal to outside the semiconductor integrated circuit,
the power line for supplying a power supply voltage to the clock driver and the power line for supplying a power supply voltage to the clock system circuit are formed as separate lines, and
the power line for supplying a power supply voltage to the clock system circuit and the power line for supplying a power supply voltage to the clock driver are isolated from each other in the semiconductor integrated circuit and in the semiconductor package.

4. The semiconductor device of claim 1, wherein the non-clock system circuit includes a data driver for outputting a processing result in the semiconductor integrated circuit to outside the semiconductor integrated circuit,
the power line for supplying a power supply voltage to the data driver and the power line for supplying a power supply voltage to the non-clock system circuit are formed as separate lines, and
the power line for supplying a power supply voltage to the non-clock system circuit and the power line for supplying a power supply voltage to the data driver are isolated from each other in the semiconductor integrated circuit and in the semiconductor package.

5. A semiconductor device, comprising:
a clock signal transmission line formed on a semiconductor printed board;
a termination circuit placed at a termination of the clock signal transmission line and configured to suppress reflection of a clock signal; and
a power supply for supplying a power supply voltage to the termination circuit,
wherein the power supply associated with the termination circuit is isolated from another power supply.

6. The semiconductor device of claim 5, wherein the power supply associated with the termination circuit is isolated from said another power supply by AC termination using a low-pass filter.
